(19) United States
(12) Patent Application Publication
(10) Pub. No.: US 2022/0254184 A1
(43) Pub. Date: Aug. 11, 2022

(54) DEVICE FOR UNDER-SCREEN OPTICAL FINGERPRINT-IDENTIFICATION

(71) Applicant: Wuhan China Star Optoelectronics Technology Co., Ltd., Wuhan (CN)

(72) Inventors: Guiyang ZHANG, Wuhan (CN); Qi WEI, Wuhan (CN)

(21) Appl. No.: 16/763,346

(22) PCT Filed: Nov. 8, 2019
(86) PCT No.: PCT/CN2019/116734

§ 371 Date: May 12, 2020

(30) Foreign Application Priority Data
Oct. 29, 2019 (CN) 201911034449.9

(51) Int. Cl. G06V 40/13; G06V 40/12; G02F 1/1333; G02F 1/1335; G02F 1/163

(52) U.S. Cl. CPC G06V 40/1318; G06V 40/1365; G02F 1/13338; G02F 1/133504; G02F 2201/305; G02F 1/133528; G02F 1/163; G02F 2001/1635; G02F 1/133521

(57) ABSTRACT

The present application provides a device for under-screen optical fingerprint-identification, which includes a display panel and a fingerprint-identification unit array, wherein the fingerprint-identification unit array is disposed inside the display panel, and includes a plurality of fingerprint-identification units and a plurality of diffraction grating layers. Additional optical structures can be excluded to prevent receiving large-angle interfered light signals by using the fingerprint-identification units having diffraction grating layers according to the present application, so that a thickness of the entire device can be greatly reduced.

### TECHNICAL FIELD

The present application relates to the field of display technology, and more particularly, to a device for under-screen fingerprint-identification.

### BACKGROUND

Currently, fingerprint-identification technologies are mainly divided into ultrasonic fingerprint-identification, capacitive fingerprint-identification, and optical fingerprint identification. All three fingerprint-identification technologies use different feedback effects produced by ridges and valleys of a finger with respect to a same detection signal to identify. It is difficult for the capacitive fingerprint-identification under a screen to identify a user's fingerprint, so an identification module is usually additionally designed and disposed outside the screen to collect user's fingerprint information by adopting a plug-in approach. For example, the identification module is placed at a phone's home button or at the back of the phone, so a screen-to-body ratio is reduced. The ultrasonic fingerprint-identification also usually adopts the plug-in approach. If the ultrasonic fingerprint-identification is disposed under the screen to collect fingerprints, it has problems of low identification rate and low identification speed. The traditional fingerprint-identification technology usually utilizes an optical system to image a fingerprint on a signal acquisition surface for identification. However, the optical system is large in size. It can be accommodated in a traditional fingerprint door lock or a fingerprint attendance machine, but for smaller devices such as smartphones and tablets, such a large optical-path system cannot be adopted. Therefore, most previous ultra-thin display devices use the ultrasonic and the capacitive fingerprint-identification technology.

Optical fingerprint identification under a screen can be achieved by emitting the light emitted by a device itself to a fingerprint and then collecting the light reflected by the fingerprint for fingerprint identification. But the light reflected by the fingerprint would be scattered within a certain angle range. The light reflected by different fingerprints may be received and sensed by the same sensor, which causes confusion in identification. Therefore, in the prior art, an optical path system is added to filter out other interfered light as much as possible to collect fingerprint information corresponding to the sensor.

As shown in FIGS. 1A and 1B, FIG. 1A is a schematic diagram showing a device for optical fingerprint-identification, adopting a black matrix 101, according to a prior art. FIG. 1B is a schematic diagram showing an arrangement of sub-pixel units 102 and optical fingerprint-identification units 10, according to the prior art. In the prior art, optical fingerprint-identification units 10 are disposed below an entire display panel (not shown), and are arranged below an adjusted black matrix (BM) 101 and sub-pixel units 102. Valid fingerprint signal light passes through by adjusting the geometric size of the black matrix 101, and then the optical fingerprint-identification units 10 receive the valid fingerprint signal light, thereby increasing a signal-to-noise ratio of signals received by the fingerprint identification units. However, the above approach may cause great loss of display aperture ratio and display resolution due to the arrangement of the black matrix 101.

China Patent No. CN109740556A discloses that in order to prevent large-angle light from cross-talk, it is necessary to form multiple black matrix layers, that is, to form multiple shielding film layers which are patterned and arranged in a matrix to block the interference of large-angle light, but a thickness of an entire device would be increased in this manner. Therefore, China Patent No. CN109740556A proposes a fingerprint-identification module for reducing a thickness of a device. The collimation light entering fingerprint-identification sensors is achieved by forming an optical structure with an upper and a lower nano grating layer and a polymer dispersed liquid crystal layer on a fingerprint-identification sensor array. That is, the purpose of the fingerprint-identification still needs to be achieved by multiple thin film optical structures. Therefore, the fingerprint-identification sensor array may only be disposed at a backplate, and the location of the fingerprint-identification sensors cannot be disposed flexibly.

Therefore, in order to resolve problems of the reduction of the display aperture ratio, the display resolution, and the increase of the thickness of the entire device, it is necessary to provide a device for under-screen optical fingerprint-identification to resolve the problems of the prior art.

### TECHNICAL PROBLEM

An objective of the present application is to provide a device for under-screen optical fingerprint-identification to resolve problems of loss of display aperture ratio, display resolution, and the increase of a thickness of a device of the prior art.

### TECHNICAL SOLUTION

In order to achieve above objective, an aspect of the present application provides a device for under-screen optical fingerprint-identification, including
a display panel; and
a fingerprint-identification unit array disposed inside the display panel, including a plurality of fingerprint-identification units and a plurality of diffraction grating layers, the plurality of fingerprint-identification units and the plurality of diffraction grating layers formed at a same structural layer of the display panel, the plurality of fingerprint-identification units having a light-sensing function and configured to generate sensed fingerprint signals, and the plurality of diffraction grating layers configured to filter undesired interfered light during fingerprint identification,
wherein the plurality of fingerprint-identification units and the plurality of diffraction grating layers are arranged in a manner of one-to-one correspondence.

Further, each of the diffraction grating layers includes a plurality of light transmittance areas and a plurality of opaque areas, the plurality of light transmittance areas include a plurality of slits parallel to each other, the plurality of opaque areas are located between the slits, and the plurality of light transmittance areas and the plurality of opaque areas are arranged alternatively.

Further, the diffraction grating layer has high transmittance with respect to small-angle incident light and has low transmittance with respect to large-angle incident light, to reduce diffraction efficiency of interfered light at a large angle.

Further, when an angle between incident light and the diffraction grating layers ranges from 0 to 10 degrees, diffraction efficiency of interfered light at a large angle greater than 10 degrees is less than or equal to 10%.

Further, each of the diffraction grating layers is integrated into one of the plurality of fingerprint-identification units.

Further, each of the diffraction grating layers is disposed on one of the plurality of fingerprint-identification units.

Further, each of the fingerprint-identification units further includes a transparent connection layer, which is configured to connect each of the diffraction grating layers to one of the plurality of fingerprint-identification units.

Further, the display panel is a liquid crystal display (LCD) panel which includes:
a lower polarization layer;
a thin-film transistor (TFT) array substrate located on the lower polarization layer;
a color filter substrate disposed opposite to the TFT array substrate;
a liquid crystal layer disposed between the TFT array substrate and the color filter substrate; and
an upper polarization layer located on the color filter substrate.

Optionally, the fingerprint-identification unit array is disposed between the lower polarization layer and the TFT array substrate.

Optionally, the fingerprint-identification unit array is disposed on the TFT array substrate, and is located between the TFT array substrate and the liquid crystal layer.

Optionally, the fingerprint-identification unit array is disposed on the color filter substrate, and is located between the color filter substrate and the liquid crystal layer.

Optionally, the fingerprint-identification unit array is disposed between the color filter substrate and the upper polarization layer.

Further, the display panel is an organic light-emitting diode (OLED) display panel, which includes:
a thin-film transistor (TFT) array substrate;
a plurality of sub-pixel units located on the TFT array substrate;
an encapsulation layer located on the plurality of sub-pixel units; and
a polarization layer located on the encapsulation layer.

Optionally, the fingerprint-identification unit array is disposed between the encapsulation layer and the polarization layer.

Optionally, the fingerprint-identification unit array is disposed between the TFT array substrate and the encapsulation layer.

### BENEFICIAL EFFECT

Since the diffraction grating is only a few micrometers, the device for under-screen optical fingerprint identification according to the present application is not limited to the size restrictions brought by an optical system, so there is no great demand for a module thickness of a display device. Additionally, a function of angle filtering can be achieved to filter large-angle interfered light during fingerprint identification according to the present application. In principle, the device for under-screen optical fingerprint-identification does not need the assistance of an optical structure or a black matrix, thus achieving higher display aperture ratio and display resolution. In addition, since each diffraction grating layer is integrated into each fingerprint identification unit or connected to an ontology of each fingerprint identification unit, which brings great convenience, the fingerprint-identification units having diffraction grating layers can be arranged arbitrarily according to requirements. It can be seen that the present application is practical and convenient, and it may be applied to any types of display devices. Compared with traditional fingerprint-identification technology, it has obvious advantages.

### DESCRIPTION OF DRAWINGS

FIG. 1A is a schematic diagram showing a device for optical fingerprint-identification adopting a black matrix according to a prior art.

FIG. 1B is a schematic diagram showing an arrangement of sub-pixel units and fingerprint-identification units according to the prior art.

FIG. 2A is a schematic diagram showing a diffraction grating layer according to the present invention.

FIG. 2B is a schematic diagram showing a fingerprint-identification unit having the diffraction grating layer according to a first embodiment of the present application.

FIG. 2C is a schematic diagram showing a fingerprint-identification unit having the diffraction grating layer according to a second embodiment of the present application.

FIG. 2D is a schematic diagram showing a fingerprint-identification unit having the diffraction grating layer according to a third embodiment of the present application.

FIG. 3 is a schematic diagram of the principle of a diffraction grating.

FIG. 4 is a schematic diagram showing a device for optical fingerprint-identification adopting fingerprint-identification units having diffraction grating layers according to the present application.

FIG. 5 is a distribution diagram of grating diffraction efficiency at different incident angles.

FIG. 6A is a schematic diagram showing an organic light-emitting diode (OLED) display panel according to a fourth embodiment of the present application.

FIG. 6B is a schematic diagram showing an OLED display panel according to a fifth embodiment of the present application.

FIG. 7A is a schematic diagram showing a liquid crystal display (LCD) panel according to a sixth embodiment of the present application.

FIG. 7B is a schematic diagram showing an LCD panel according to a seventh embodiment of the present application.

FIG. 7C is a schematic diagram showing an LCD panel according to an eighth embodiment of the present application.

FIG. 7D is a schematic diagram showing an LCD panel according to a ninth embodiment of the present application.

FIG. 8A is a schematic diagram showing an arrangement of sub-pixel units and a fingerprint-identification unit array according to a tenth embodiment of the present application.

FIG. 8B is a schematic diagram showing an arrangement of sub-pixel units and a fingerprint-identification unit array according to an eleventh embodiment of the present application.

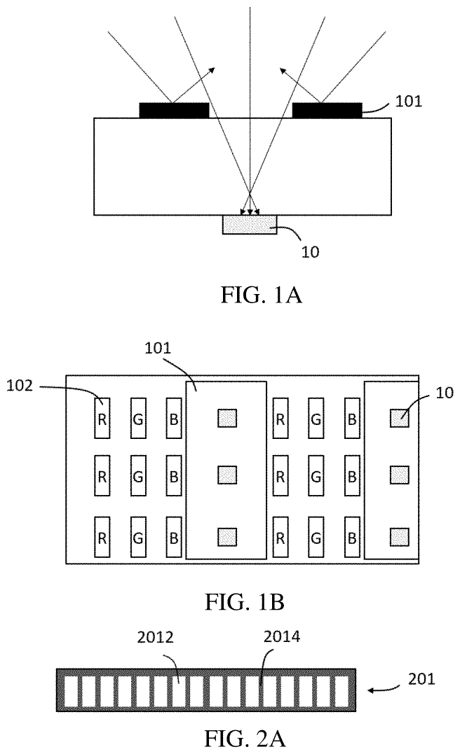

### DETAILED DESCRIPTION OF PREFERRED EMBODIMENTS

To make the objectives, technical schemes, and effects of the present application clearer and more specific, the present application is described in further detail below with reference to the embodiments in accompanying with the appending drawings. It should be understood that the specific embodiments described herein are merely for explaining the present application, the term “embodiment” used in the context means an example, instance, or illustration, and the present application is not limited thereto.

The present application provides a device for under-screen optical fingerprint identification, and the device has a function for under-screen optical fingerprint identification and includes a display panel and a fingerprint-identification unit array, wherein the fingerprint-identification unit array is disposed inside the display panel and includes a plurality of fingerprint-identification units and a plurality of diffraction grating layers. The plurality of fingerprint-identification units and the plurality of diffraction grating layers are formed at a same structural layer of the display panel. The plurality of fingerprint-identification units have a light-sensing function and are configured to generate sensed fingerprint signals. The plurality of diffraction grating layers are configured to filter undesired interfered light during fingerprint identification. By arranging the plurality of diffraction grating layers and the plurality of fingerprint-identification units in a manner of one-to-one correspondence, that is, by forming each of diffraction grating layers on one of the plurality of fingerprint-identification units, large-angle interfered light is reduced without the aid of a black matrix (BM) or an optical structure, thereby increasing display aperture ratio, display resolution, and reducing a thickness of the entire device. It is understood that “the fingerprint identification unit array” may stand for “a plurality of fingerprint-identification units having diffraction grating layers” described below in the specification.

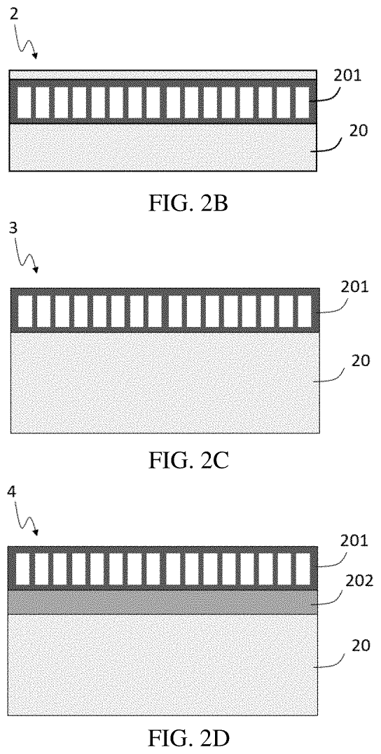

Referring to FIG. 2A, it is a schematic diagram showing a diffraction grating layer 201 according to the present invention. Each diffraction grating layer 201 includes a plurality of light transmittance areas 2012 and a plurality of opaque areas 2014, the plurality of light transmittance areas 2012 includes a plurality of slits parallel to each other, and the plurality of opaque areas 2014 are located between the slits, that is, the plurality of light transmittance areas 2012 and the plurality of opaque areas 2014 are arranged alternatively.

In the embodiment, the plurality of slits parallel to each other may be slits arranged in periodical or regular. The present application does not limit the arrangement of the plurality of slits parallel to each other.

In the present embodiment of the present application, the diffraction grating layer 201 may be an amplitude grating or a sinusoidal grating, or the like.

Referring to FIG. 2B, it is a schematic diagram showing a fingerprint-identification unit having the diffraction grating layer 2 according to a first embodiment of the present application. The diffraction grating layer 201 can be integrated into the fingerprint-identification unit 20 during development and etching processes of manufacturing the fingerprint-identification unit 20, and the integrated structure does not occupy display areas outside the fingerprint-identification unit 20 at all. It can be seen that an optical structure added for solving the large-angle interfered light may be entirely removed according to the present application, thereby reducing a thickness requirement of the device. The present application does not limit to the manufacturing method, and it also does not limit to the manner in which the diffraction grating layer 201 is embedded or fabricated in the fingerprint-identification unit 20.

Referring to FIG. 2C, it is a schematic diagram showing a fingerprint-identification unit having the diffraction grating layer 3 according to a second embodiment of the present application. The diffraction grating layer 201 can be formed on the fingerprint-identification unit 20 by means of nanoimprint, electron-beam etching, or ion beam etching, or the like, to form a fingerprint-identification unit having the diffraction grating layer 201 3. The present application does not limit to the manufacturing method, and it also does not limit to the manner in which the diffraction grating layer 201 is formed on an outer surface of the fingerprint-identification unit 20.

Referring to FIG. 2D, it is a schematic diagram of a fingerprint-identification unit having the diffraction grating layer 4 according to a third embodiment of the present application. The diffraction grating layer 201 may be connected to the fingerprint-identification unit 20 through a transparent connection layer 202 (such as an optical clear adhesive) to form a fingerprint-identification unit having the diffraction grating layer 201 4. The present application does not limit to the transparent connection layer 202, and the present application also does not limit to the manner in which the diffraction grating layer 201 is connected to the fingerprint-identification unit 20 through the transparent connection layer 202. For the sake of convenience, the first embodiment of the present application is used to illustrate and enumerate for the drawings below.

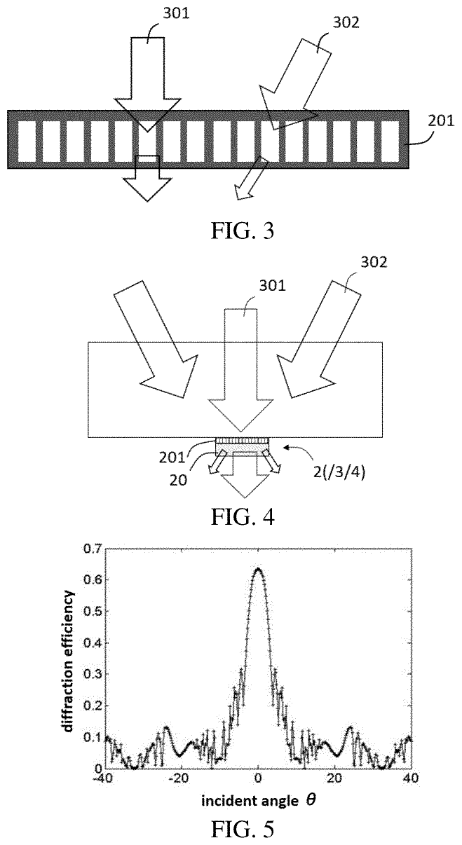

Referring to FIG. 3, it is a schematic diagram of a principle of a diffraction grating. In the present application, the diffraction grating layer 201 has different diffraction effects with respect to incident light at different angles. When an incident light perpendicular to a grating passes through the grating, and a difference of diffracted optical path is an integer multiple of the wavelength of the light, that is, it corresponds to 2dsinθ=mλ (D is distances between the slits, θ is a diffraction angle, m is an integer, and θ is the wavelength of the light.), light rays interfere with each other to form bright streaks, wherein a strongest bright streak is at the center, and the intensity of the bright streaks decreases non-linearly as the distance from the center decreases, which means that the grating itself has the characteristics of strong bright streaks at the central and weak surrounding bright streaks. Specifically, a small-angle incident light 301 is an valid fingerprint signal light with a large vertical incidence component in the present embodiment, and when the small-angle incident light 301 passes through, the diffraction grating layer 201 has high transmission and high diffraction efficiency with respect to the small-angle incident light 301, so higher energy signals may be received. Additionally, a large-angle incident light 302 is an invalid fingerprint signal light or a background noise signal light with a small vertical incidence component in the present embodiment, and when the large-angle incident light 302 passes through, the diffraction grating layer 201 has low transmission and low diffraction efficiency with respect to the large-angle incident light 302, so lower energy signals are received. Specifically, since the large-angle incident light 302 itself has the small vertical incidence component, the intensity of the bright streaks generated by the large-angle incident light 302 is lower than the intensity of the bright streaks generated by the small-angle incident light 301, that is, the intensity of the large-angle invalid fingerprint signal light is lower than the intensity of the small-angle valid fingerprint signal light, whereby fingerprint information can be effectively identified.

Referring to FIG. 4, it is a schematic diagram showing a device for optical fingerprint-identification adopting fingerprint-identification units having diffraction grating layers 2, 3 or 4 according to the present application. The light reflected by a fingerprint (including a small-angle incident light 301 and a large-angle incident light 302) first passes through a diffraction grating layer 201, and then a fingerprint-identification unit 20 located below the diffraction grating layer 201 will simultaneously receive small-angle diffracted light with a higher energy signal and large-angle diffracted light with a lower energy signal. Due to the difference in energy, the fingerprint-identification unit having the diffraction grating layer 2, 3, or 4 receives signals with a higher signal-to-noise ratio (SNR), so a valid fingerprint signal can be easily identified.

In the embodiment, the distribution of different grating diffraction efficiency may be adjusted by setting the parameters of a grating, such as a refractive index of a material, a grating period, and a duty ratio of the grating. Preferably, in conjunction with FIG. 5, it is a distribution diagram of grating diffraction efficiency at different incident angles. The grating has a refractive index of about 1.55, a grating period of 0.5 μm, and a duty ratio of 0.3. The horizontal axis of the distribution diagram corresponds to incident angles and the vertical axis of the distribution diagram corresponds to diffraction efficiency. It can be seen that the diffraction efficacy of signal light is about 65% in the range of 0 to 10 degrees, and the diffraction efficiency of the other large-angle interfered light is about 10%. At this time, most of optical signals received by the fingerprint-identification unit having the diffraction grating layer 2 come from effective fingerprint area at a small angle, and a light proportion comes from the invalid interfered area is small, so fingerprint information can be effectively identified.

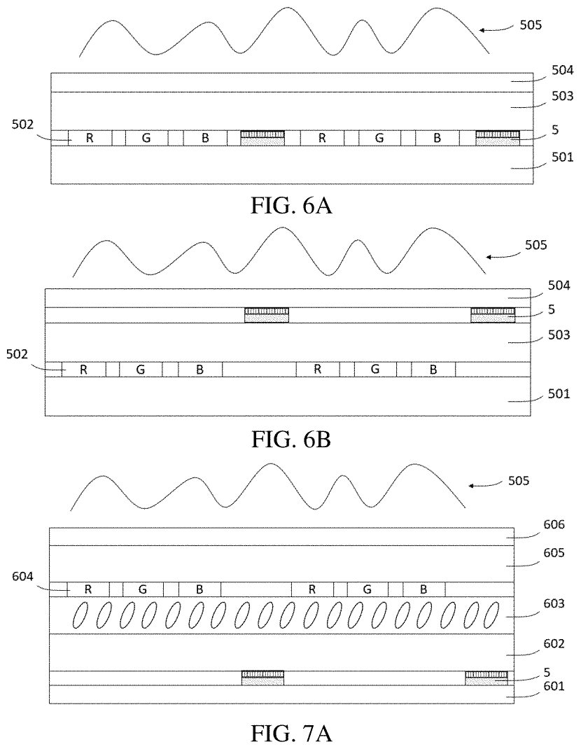

Referring to FIGS. 6A and 6B, they are schematic diagrams showing organic light-emitting diode (OLED) display panels according to a fourth embodiment and a fifth embodiment of the present application, respectively. The OLED display panel includes a thin-film transistor array (TFT array) substrate 501, and a plurality of sub-pixel units 502, an encapsulation layer 503, and a polarization layer 504 are sequentially disposed on the TFT array substrate 501. The sub-pixel units 502 are organic light-emitting units, the thin-film transistor array substrate 501 is used to drive the plurality of sub-pixel units 502 illuminate, the encapsulation layer 503 is used to prevent water and oxygen from permeating, and the polarization layer 504 is used to generate polarized light. The OLED display panel further includes a fingerprint-identification unit array 5, which may be disposed between the TFT array substrate 501 and the encapsulation layer 503 (as shown in FIG. 6A) or be disposed between the encapsulation layer 503 and the polarization layer 504 (as shown in FIG. 6B). An OLED function layer includes a plurality of anodes and cathodes, and the plurality of sub-pixel units 502 which are organic light emitting layers, and each of the sub-pixel units 502 is disposed between the anode and the cathode (not shown). In an embodiment, the fingerprint-identification unit array 5 may be specifically located on the same film layer as the anode and located at the gaps between the anodes, or located on the same film layer as the cathode and located at the gaps between the cathodes, it is prepared by development and etching process. Additionally, the fingerprint-identification unit array 5 may also first be formed on the polarization layer 504 by development and etching processes, and one side of the polarization layer 504 on which the fingerprint-identification unit array 5 is formed is then bonded to the encapsulation layer 503 formed on the thin film transistor array substrate 501, so that the fingerprint-identification unit array 5 is located between the polarization layer 504 and the encapsulation layer 503.

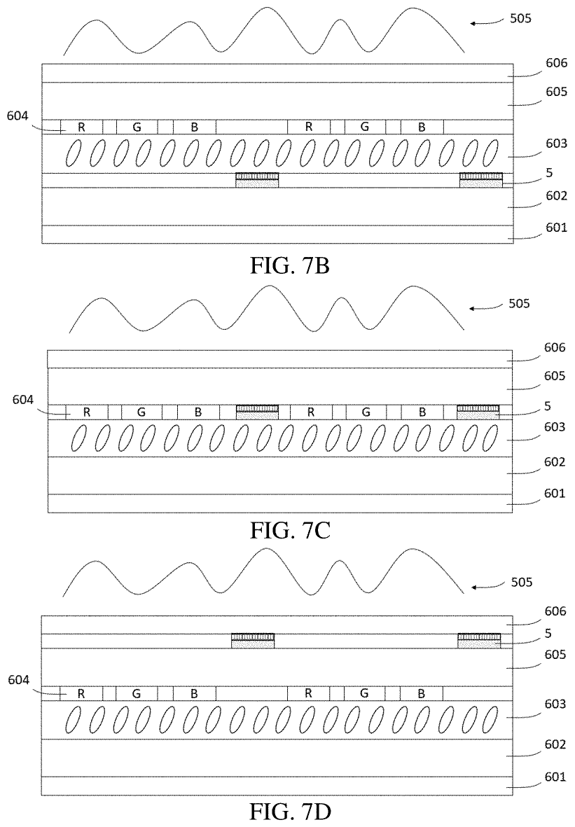

Referring to FIGS. 7A to 7D, they are schematic diagrams showing liquid crystal display (LCD) panels according to a sixth embodiment to a ninth embodiment of the present application, respectively. The LCD panel includes a lower polarization layer 601 and a TFT array substrate 602 disposed on the lower polarization layer 601. A liquid crystal layer 603, a counter substrate 605, and an upper polarization layer 606 are sequentially disposed on the TFT array substrate 602. The TFT array substrate 602 includes a plurality of red sub-pixels, a plurality of blue sub-pixels, and a plurality of green sub-pixels. The counter substrate 605 is a substrate such as a glass substrate, the liquid crystal layer 603 is disposed between the TFT array substrate 602 and the counter substrate 605, and the lower polarization layer 601 and the upper polarization layer 606 are configured to generate polarized light.

Furthermore, the LCD panel further includes a plurality of color filter (CF) units 604, and the plurality of color filter units 604 are used for filtering light and include a plurality of red color resists, a plurality of blue color resists, and a plurality of green color resist, which may be formed on the TFT array substrate 602 or on the counter substrate 605. When the plurality of color filter units 604 are formed on the TFT array substrate 602, the counter substrate 605 is a glass or a plastic substrate used for providing a common voltage. When the plurality of color filter units 604 are formed on the counter substrate 605, the counter substrate 605 is called color filter substrate. Specifically, the plurality of color filter units 604 are disposed on a side of the color filter substrate facing the TFT array substrate 602. For the sake of convenience, FIGS. 7A to FIG. 7D are schematic diagrams showing a case in which the counter substrate 605 is the color filter substrate.

In the embodiment, the LCD display panel further includes a fingerprint-identification unit array 5, which may be disposed between the lower polarization layer 601 and the TFT array substrate 602 (as shown in FIG. 7A), between the TFT array substrate 602 and the liquid crystal layer 603 (as shown in FIG. 7B), between the liquid crystal layer 603 and the counter substrate 605 (as shown in FIG. 7C), or between the counter substrate 605 and the upper polarization layer 606 (as shown in FIG. 7D).

Furthermore, when the counter substrate is the color filter substrate, the fingerprint-identification unit array 5 is disposed between the liquid crystal layer 603 and the color filter substrate (see FIG. 7C), and the plurality of color filter units 604 and the fingerprint-identification unit array 5 may be located on the same film layer. In another embodiment, the fingerprint-identification unit array 5 is disposed between the color filter substrate and the upper polarization layer 606 (see FIG. 7D).

Specifically, the fingerprint-identification unit array 5 may be integrated into a buffer layer (not shown) or a passivation layer (not shown) in the TFT array substrate 602 by development and etching processes, or may be formed on a side of TFT array substrate 602 facing the lower polarization layer 601, on a side of the counter substrate 605 facing the liquid crystal layer 603, or on a side of the counter substrate 605 facing the upper polarization layer 606 by development and etching processes.

Compared with a structure occupying a large area according to the prior art, by combining a diffraction grating layer with a few micrometers with each of fingerprint-identification units (such as CMOS), that is, each fingerprint-identification unit corresponds to one diffraction grating layer, the fingerprint-identification units and the diffraction grating layers are arranged in a manner of one-to-one correspondence, which means that all each individual fingerprint-identification unit having the diffraction grating layer may achieve a function for angle filtering and an effect of thin and light devices. Without the size restrictions brought by the traditional optical system, a thickness requirement of the device is reduced. Furthermore, compared with the prior art, no matter how the size of an optical system can be reduced, the optical system is still composed of multiple film layers or multiple optical structures, identification sensors may only be placed under an entire display panel and arranged under the optical structures and sub-pixel units, so there is no big change of the position of the identification sensors. Since the diffraction grating layer according to the present application is integrated into or connected to each fingerprint-identification unit, it brings great convenience, so the fingerprint-identification units having the diffraction grating layers may be arbitrarily arranged and more flexibly disposed at many positions of a display panel. It is understood that when the fingerprint-identification units having the diffraction grating layers 2 are disposed at different positions in the display panel, the light intensity reflected by a fingerprint and a fingerprint signal-to-noise ratio which are collected are different. Therefore, when the fingerprint-identification units having the diffraction grating layers 2 get closer to the fingerprint 505, there will be less interference with the light reflected by the fingerprint 505, and a higher identification rate for under-screen fingerprint-identification may be increased. The present application is applicable to various forms of display devices, such as LCD, OLED, QLED and micro LED display.

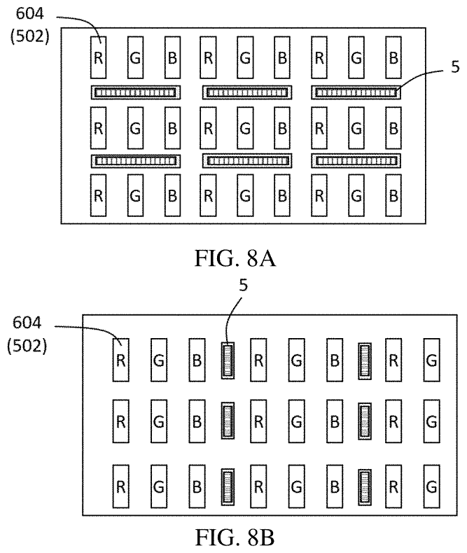

In conjunction with FIGs.8A and 8B, they are arrangements of sub-pixel units 604 (502) and a fingerprint-identification unit array 5 according to a tenth embodiment and an eleventh embodiment of the present application, respectively. Herein, the top views show the relative position between the sub-pixel units 604 (502) and the fingerprint-identification unit array 5 in horizontal. It should be understood that the sub-pixel units 604 (502) and the fingerprint-identification unit array 5 may be located at the same layer or at different layers. As shown in FIG. 8A, one fingerprint-identification unit having a diffraction grating layer is arranged corresponding to three sub-pixel units of a red pixel sub-unit R, a green pixel sub-unit G, and a blue pixel sub-unit B, and is arranged along a direction of short sides of the sub-pixel units 604 (502). As shown in FIG. 8B, one fingerprint-identification unit having a diffraction grating layer is arranged corresponding to three sub-pixel units of a red sub-pixel unit R, a green sub-pixel unit G, and a sub-blue pixel unit B, and is arranged along a direction of long sides of the sub-pixel units 604 (502). It should be understood that there are various arrangements according to different combinations between the sub-pixel units 604 (502) and changes in the position of the fingerprint-identification unit array 5, which are not listed here one by one.

In summary, the objective of the present application is not to completely block the light source of invalid fingerprint signals, but to increase SNR by arranging the diffraction grating layers, so that fingerprint information can be effectively identified. Moreover, in the present application, additional optical structures are excluded to prevent receiving large-angle interfered light signals, so that a thickness of the entire device can be greatly reduced.

Although the present application has been disclosed above in the preferred embodiments, the above preferred embodiments are not intended to limit the present application. For persons skilled in this art, various modifications and alterations can be made without departing from the spirit and scope of the present application. The protective scope of the present application is subject to the scope as defined in the claims.

What is claimed is:

1. A device for under-screen optical fingerprint identification, comprising:
a display panel; and
a fingerprint-identification unit array disposed inside the display panel, comprising a plurality of fingerprint-identification units and a plurality of diffraction grating layers, the plurality of fingerprint-identification units and the plurality of diffraction grating layers formed at a same structural layer of the display panel, the plurality of fingerprint-identification units having a light-sensing function and configured to generate sensed fingerprint signals, and the plurality of diffraction grating layers configured to filter undesired interfered light during fingerprint identification,
wherein the plurality of fingerprint-identification units and the plurality of diffraction grating layers are arranged in a manner of one-to-one correspondence.

2. The device as claimed in claim 1, wherein each of the diffraction grating layers comprises a plurality of light transmittance areas and a plurality of opaque areas, the plurality of light transmittance areas comprise a plurality of slits parallel to each other, the plurality of opaque areas are located between the slits, and the plurality of light transmittance areas and the plurality of opaque areas are arranged alternatively.

3. The device as claimed in claim 1, wherein the diffraction grating layer has high transmittance with respect to small-angle incident light and has low transmittance with respect to large-angle incident light, to reduce diffraction efficiency of interfered light at a large angle.

4. The device as claimed in claim 1, wherein when an angle between incident light and the diffraction grating layers ranges from 0 to 10 degrees, diffraction efficiency of interfered light at a large angle greater than 10 degrees is less than or equal to 10%.

5. The device as claimed in claim 1, wherein each of the diffraction grating layers is integrated into one of the plurality of fingerprint-identification units.

6. The device as claimed in claim 1, wherein each of the diffraction grating layers is disposed on one of the plurality of fingerprint-identification units.

7. The device as claimed in claim 1, wherein each of the fingerprint-identification units further comprises a transparent connection layer, which is configured to connect each of the diffraction grating layers to one of the plurality of fingerprint-identification units.

8. The device as claimed in claim 1, wherein the display panel is a liquid crystal display (LCD) panel, which comprises:
a lower polarization layer;
a thin-film transistor (TFT) array substrate located on the lower polarization layer;
a color filter substrate disposed opposite to the TFT array substrate;
a liquid crystal layer disposed between the TFT array substrate and the color filter substrate; and
an upper polarization layer located on the color filter substrate.

9. The device claimed as claim 8, wherein the fingerprint-identification unit array is disposed between the lower polarization layer and the TFT array substrate.

10. The device claimed as claim 8, wherein the fingerprint-identification unit array is disposed on the TFT array substrate, and is located between the TFT array substrate and the liquid crystal layer.

11. The device claimed as claim 8, wherein the fingerprint-identification unit array is disposed on the color filter substrate, and is located between the color filter substrate and the liquid crystal layer.

12. The device claimed as claim 8, wherein the fingerprint-identification unit array is disposed between the color filter substrate and the upper polarization layer.

13. The device claimed as claim 1, wherein the display panel is an organic light-emitting diode (OLED) display panel, which comprises:
a thin-film transistor (TFT) array substrate;
a plurality of sub-pixel units located on the TFT array substrate;
an encapsulation layer located on the plurality of sub-pixel units; and
a polarization layer located on the encapsulation layer.

14. The device claimed as claim 13, wherein the fingerprint-identification unit array is disposed between the encapsulation layer and the polarization layer.

15. The device claimed as claim 13, wherein the fingerprint-identification unit array is disposed between the TFT array substrate and the encapsulation layer.
